(19) United States
(12) Patent Application Publication
(10) Pub. No.: US 2012/0240410 A1
(43) Pub. Date: Sep. 27, 2012

(54) Cutting Tool

(75) Inventor: Sheng-Chih Chiu, Taichung City (TW)

(73) Assignee: ASIAN FIRST REFRIGERATION CORPORATION, Taichung City (TW)

(21) Appl. No.: 13/176,450

(22) Filed: Jul. 5, 2011

Related U.S. Application Data
(63) Continuation-in-part of application No. 13/072,113, filed on Mar. 25, 2011.

(51) Int. Cl. B23D 21/08

(52) U.S. Cl. 30/102

(57) ABSTRACT

A cutting tool includes a body, a moving base, and a roller base. The body has a rail groove, whose one side is extended upward with a stopping wall. The moving base is disposed in the rail groove of the body and has a cutting wheel. The moving base is connected with a transmission element and driven by the transmission element to move along the rail groove. The roller base is interposed between the moving base and the stopping wall. There are a plurality of elastic elements between the roller base and the stopping wall. The roller base is disposed with at least two rollers opposite to the cutting wheel.

### CROSS-REFERENCE TO RELATED APPLICATION

This application is a Continuation-In-Part Application of Ser. No. 13/072,113, filed on Mar. 25, 2011, and entitled “IMPROVED STRUCTURE OF A CUTTING TOOL”, now pending.

### BACKGROUND OF THE INVENTION

1. Field of Invention

The invention relates to a hand tool and, in particular, to a cutting tool that can firmly hold a tube.

2. Related Art

FIG. 8 shows the structure of a conventional tube cutter. By turning a knob 51, a rolling cutter 52 moves toward two rollers 53 to hold a tube 54. As one turns the knob 51 with force, the rolling cutter 52 cuts the tube 54.

However, in the conventional tube cutter structure, the rollers 53 are pivotally fixed to one side of the cutter. The configuration can only provide one fixed holding position. It cannot fine-tune according to the size of the tube 54 or the magnitude of exerted force. Therefore, the holding effect is not perfect. If the rolling cutter 52 and the two rollers 53 cannot firmly hold and position the tube 54, it is not only difficult for cutting but may even lead to the result that the tube 54 slips out of the rolling cutter 52 and the two rollers 53.

### SUMMARY OF THE INVENTION

An objective of the invention is to provide a cutting tool that has a simple structure, is easy to assemble, as well as provides a better tube positioning effect.

Another objective of the invention is to provide a cutting tool that can quickly hold a tube firmly.

To achieve the above-mentioned objectives, the disclosed cutting tool includes: a body, a moving base, and a roller base.

The body has a rail groove whose one side is extended upward with a stopping wall.

The bottom of the moving base is disposed in the rail groove in a sliding way. The moving base is provided with a cutting wheel. Moreover, the moving base is connected with a transmission element and driven by the transmission to move along the rail groove.

The roller base is interposed between the moving base and the stopping wall. There are a plurality of elastic elements between the roller base and the stopping wall. The roller base is installed with at least two rollers opposite to the cutting wheel.

### BRIEF DESCRIPTION OF THE DRAWINGS

These and other features, aspects and advantages of the invention will become apparent by reference to the following description and accompanying drawings which are given by way of illustration only, and thus are not limitative of the invention, and wherein:

FIG. 1 is a three-dimensional exploded view of the first embodiment of the invention;

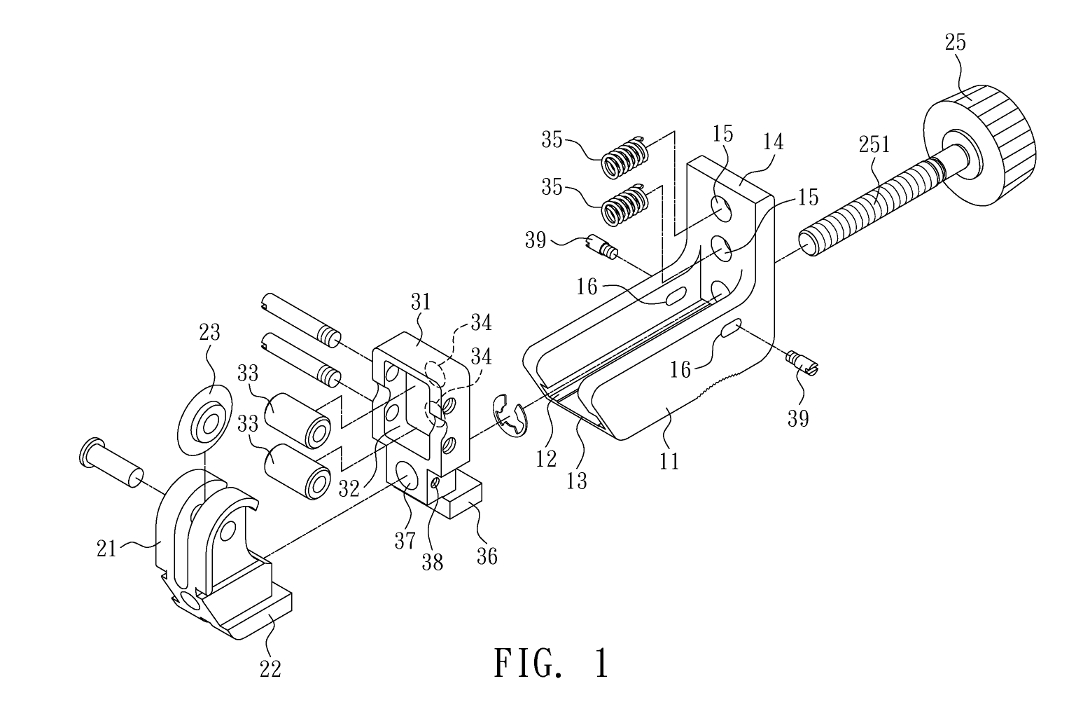

FIG. 2 is a three-dimensional view of the first embodiment of the invention;

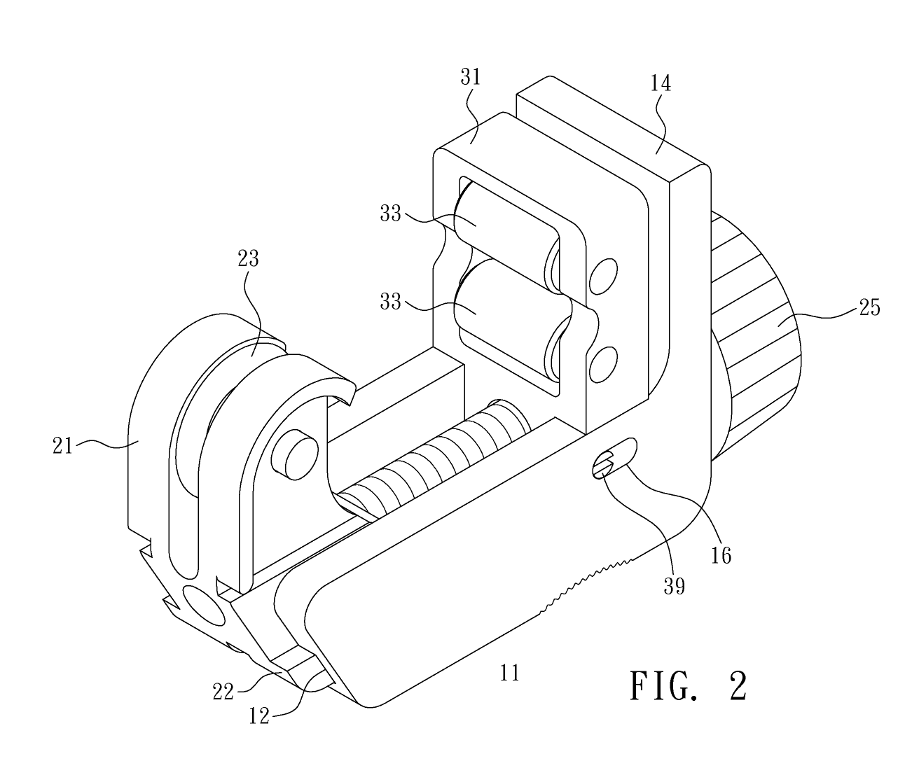

FIG. 3 is a cross-sectional view of the first embodiment of the invention;

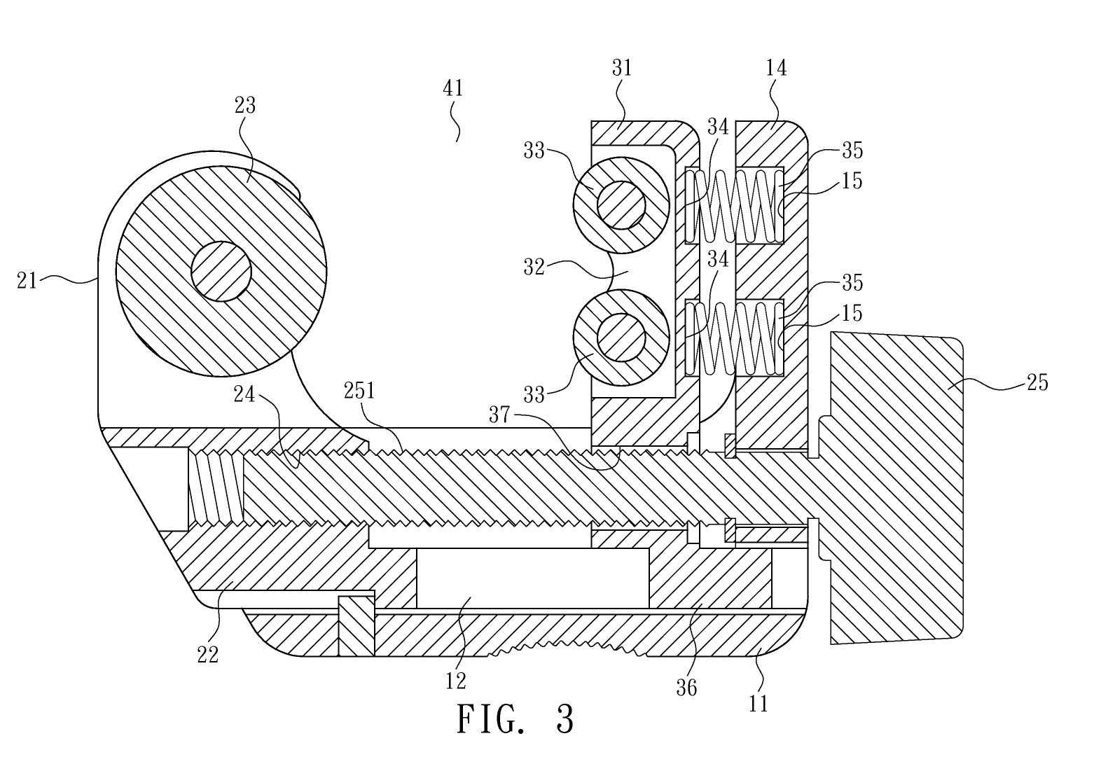

FIG. 4 shows the first embodiment in use;

FIG. 5 is a three-dimensional exploded view of the second embodiment of the invention;

FIG. 6 is a three-dimensional view of the second embodiment of the invention;

FIG. 7 is a cross-sectional view of the second embodiment of the invention; and

FIG. 8 is a schematic view of a conventional tube cutter.

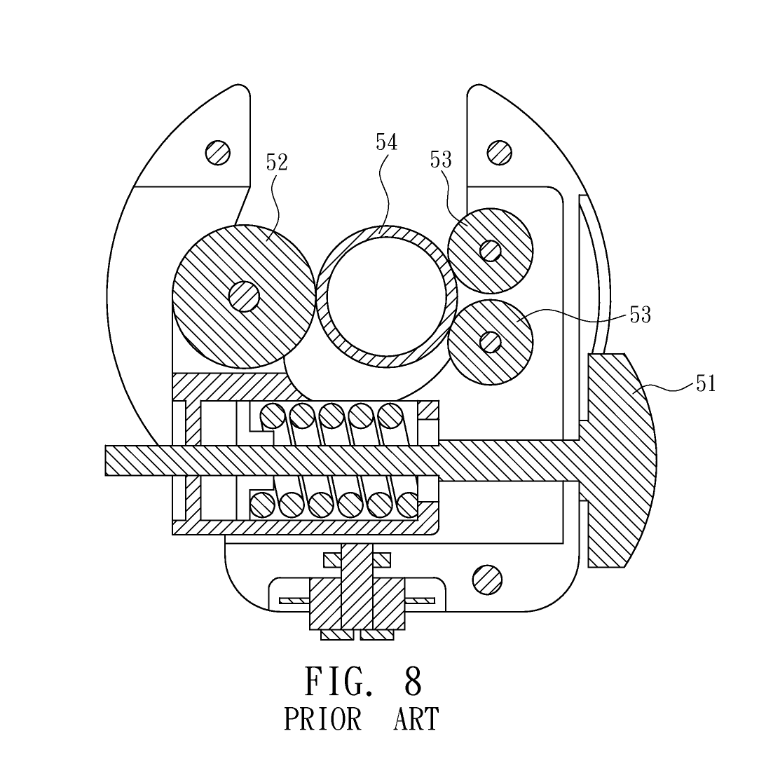

### DETAILED DESCRIPTION OF THE INVENTION

The present invention will be apparent from the following detailed description, which proceeds with reference to the accompanying drawings, wherein the same references relate to the same elements.

Please refer to FIGS. Ito 3 for the first embodiment of the invention. This invention includes a body 11, a moving base 21, and a roller base 31.

The bottom of the body 11 has a rail groove 12 extending horizontally. One side of the rail groove 12 is formed with an opening 13 to the outside, while the other side is extended upward with a stopping wall 14. The end surface of the stopping wall 14 toward the rail groove 12 is recessed with two accommodating parts 15. The two sidewalls of the body 11 opposite to the rail groove 12 are formed with a sliding groove 16, respectively.

The bottom of the moving base 21 is formed with a sliding installation part 22 corresponding to the rail groove 12. The moving base 21 is then installed in a sliding way in the rail groove 12 of the body 11. The top of the moving base 21 is installed with a cutting wheel 23. The moving base 21 has a screw hole 24 in the axial direction of the rail groove 12. A transmission element 25 has an outer thread part 251 corresponding to the screw hole 24. The transmission element 25 goes through the stopping wall 14 of the body and into the rail groove 12, connecting to the screw hole 24 of the moving base 21. When one turns the transmission element 25, the moving base 21 is driven by the transmission element 25 to move axially along the rail groove 12.

The roller base 31 is interposed between the moving base 21 and the stopping wall 14 of the body 11. The end surface of the roller base 31 toward the moving base 21 is formed with an accommodating space 32. The accommodating space 32 has two rollers 33 opposite to the cutting wheel 23. The end surface of the roller base 31 toward the stopping wall 14 has installation parts 34 corresponding to the two accommodating parts 15. An elastic element 35 is interposed between each pair of accommodating part 15 and installation part 34. One end of each of the two elastic parts 35 urges against the corresponding installation part 15 of the stopping wall 14, while the other end urges against the corresponding installation part 34 of the roller base 31. When under a force, the roller base 31 produces a shift.

In this embodiment, the bottom of the roller base 31 has a connecting part 36 corresponding to the rail groove 12 of the body 11. The connecting part 36 has a communicating hole 37 along the axial direction of the rail groove 12. The transmission element 25 first goes through the communicating hole 37 of the roller base 31 and then connects to the screw hole 24 of the moving base 21. A connecting hole 38 is formed at the position corresponding to two sliding grooves 16 of the body 11, respectively. The two connecting holes 38 have a limiting element 39, respectively. The outer diameter of the limiting element 39 is smaller than the hole diameter of the sliding groove 16. The two limiting elements 39 are installed in the corresponding sliding grooves 16. With the limiting elements 39 of the roller 31 installed in the sliding grooves 16 of the body, the shift range of the roller base 31 is limited.

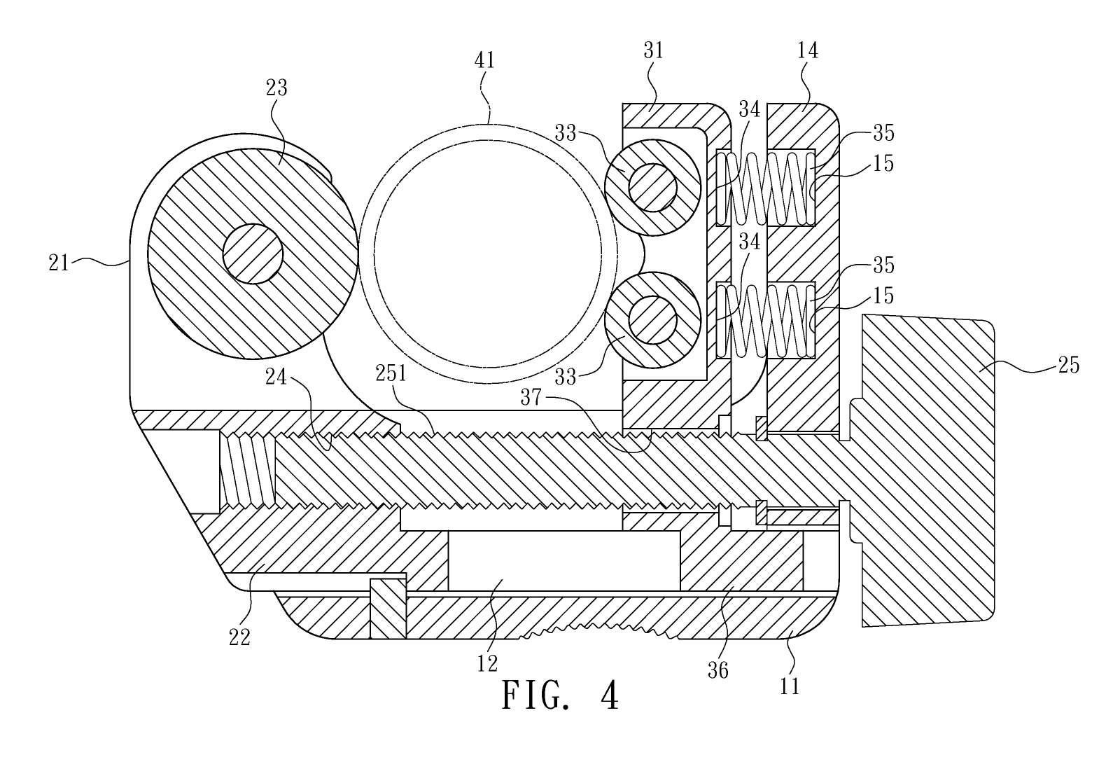

In practice, as shown in FIG. 4, a tube 41 is inserted between the cutting wheel 23 of the moving base 21 and the rollers 33 of the roller base 31. By turning the transmission element 25, the cutting wheel 23 of the moving base 21 gradually cuts toward the roller base 31. The cutting wheel 23 of the moving base 21 and the rollers 33 of the roller base 31 thus hold the outer surface of the tube 41. As urged by the elastic elements 35, the roller base 31 automatically shifts to the best holding position according to the size of the tube 41, ensuring a good holding effect. Likewise, as the disclosed cutting tool starts to cut around the tube 41, the roller base 31 also automatically shifts to the best holding position according to the exerted force. This mechanism can prevent the tube 41 from slipping out of the cutting wheel 23 and the two rollers 33.

The structure of the invention is simple. Therefore, it has the advantages of low cost, and easy and fast assembly. When the invention is in use, the roller base 31 is urged by the elastic elements 35 to have a resilient force. When the tube 41 is slightly larger than the span between the cutting wheel 23 and the two rollers 33, one can directly insert the tube 41 in between. The roller base 31 is under a force to compress the elastic elements, thereby correctly holding the tube 41. Therefore, one does not need to turn the transmission element 25 to hold the tube 41 quickly.

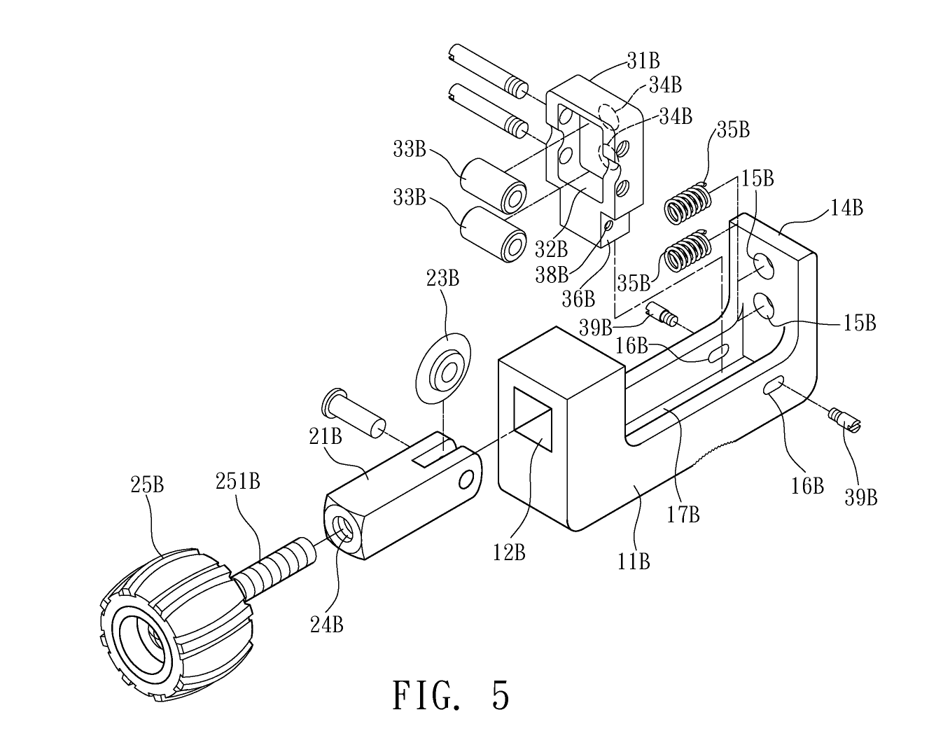

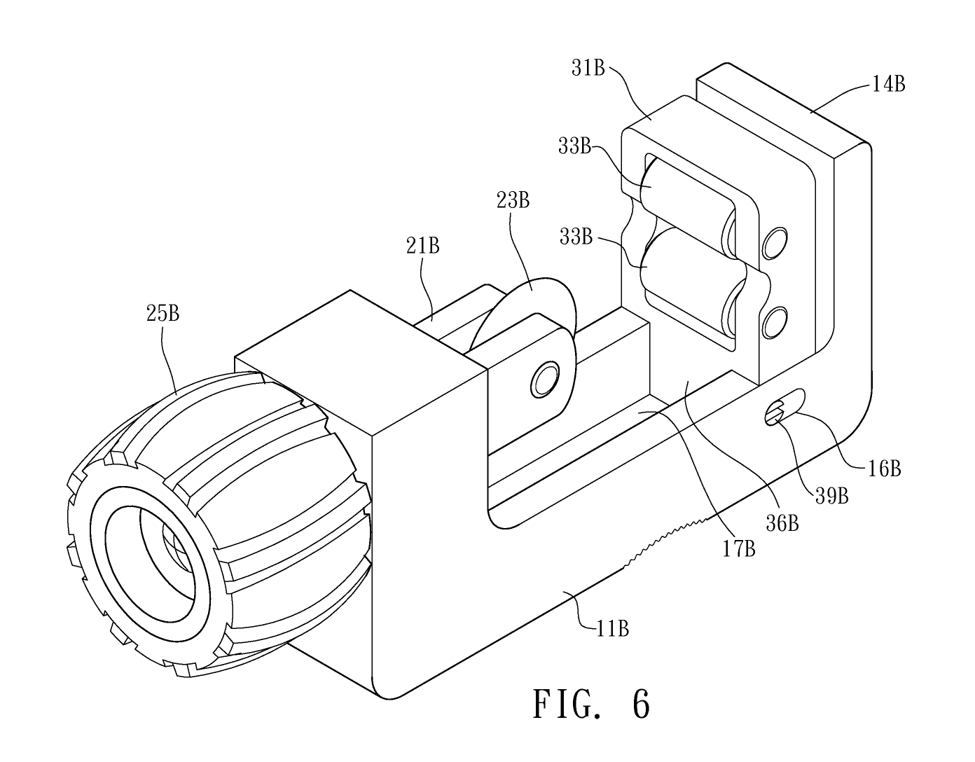

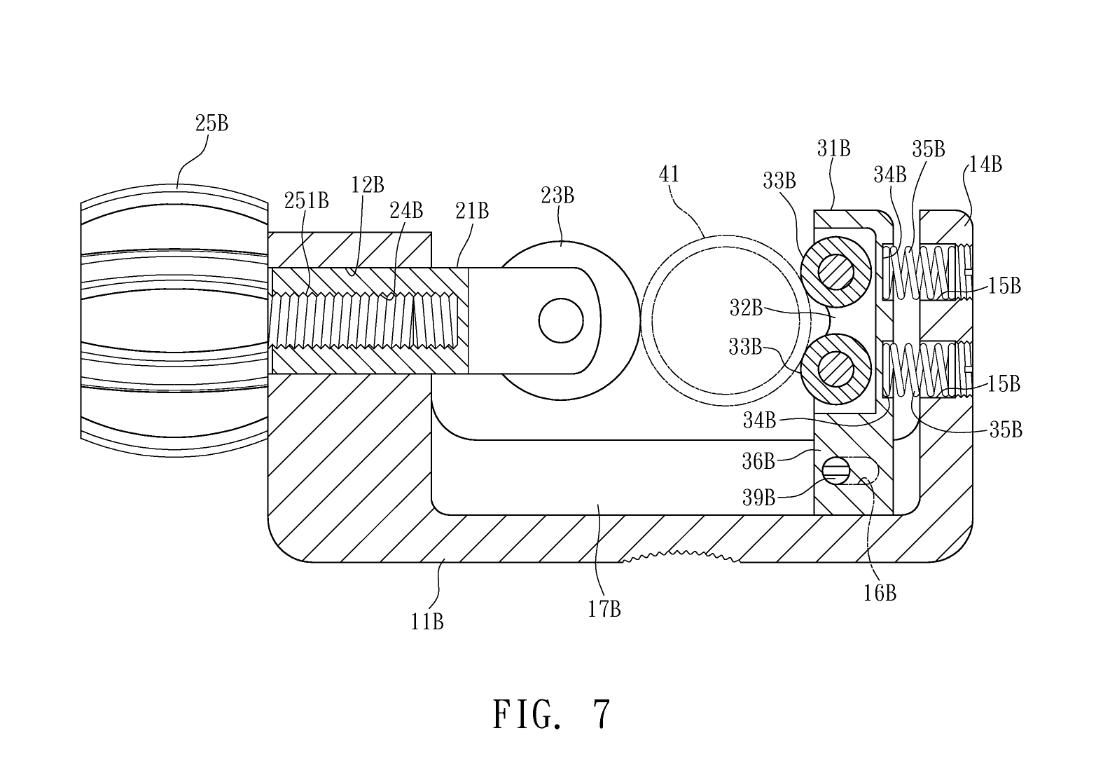

Please refer to FIGS. 5 to 7 for a second embodiment of the invention. It differs from the first embodiment in that one side of the body 11B is formed with a square rail groove 12B, while the other side away from the rail groove 12B is extended upward with a stopping wall 14B.

The moving base 21B has a pillar shape correspondingly installed in the rail groove 12B. The end of the moving base 21B toward the stopping wall 14B has a cutting wheel 23B. The moving base 21B has a screw hole 24B along the axial direction of the rail groove 12B. A transmission element 25B goes into the screw hole 24B of the moving base 21B. Moreover, the transmission element 25B is formed with an outer thread part 251 B corresponding to the screw hole 24B. As one turns the transmission element 25B, the moving base 21B is driven to move along the rail groove 12B.

A track 17B with two opposite sidewalls is formed between the rail groove 12B of the body 11B and the stopping wall 14B. The two sidewalls of the track 17B are formed with a sliding groove 16B, respectively. The bottom of the roller base 31B has a connecting part 36B corresponding to the track 17B of the body 11B. The roller base 31B is formed with a connecting hole 38B at the position opposite to the two sliding grooves 16B, respectively. A limiting element 39B is disposed in each of the two connecting holes 38B. The outer diameter of the limiting element 39B is smaller than the hole diameter of the sliding groove 16B. The two limiting elements 39 are installed in the corresponding sliding grooves 16B, respectively.

The second embodiment also uses the elastic elements 35 to urge against the roller base 31B. The roller base 31B thus automatically shifts to the best holding position according to the size of the tube 41, thereby holding it without slipping.

Although the invention has been described with reference to specific embodiments, this description is not meant to be construed in a limiting sense. Various modifications of the disclosed embodiments, as well as alternative embodiments, will be apparent to people skilled in the art. Therefore, it is contemplated that the appended claims will cover all modifications that fall within the true scope of the invention.

What is claimed is:

1. A cutting tool, comprising:
a body, which has a rail groove with one side extended upward with a stopping wall;
a moving base, which is installed in the rail groove of the body with the bottom thereof, provided with a cutting wheel, and connected to a transmission element so as to move along the rail groove under the driving force of the transmission element; and
a roller base, which is interposed between the moving base and the stopping wall, wherein a plurality of elastic elements are interposed between the roller base and the stopping wall, and the roller base is provided with at least two rollers opposite to the cutting wheel.

2. The cutting tool of claim 1, wherein the two sidewalls of the body opposite to the rail groove are formed with a sliding groove, respectively; the roller base has a connecting hole at the positions opposite to the two sliding grooves, respectively; a limiting element is disposed in the two connecting holes, respectively; the outer diameter of the limiting element is smaller than the hole diameter of the sliding groove; and the two limiting elements are installed in the corresponding sliding grooves.

3. The cutting tool of claim 1, wherein the bottom of the moving base is formed with a sliding part corresponding to the rail groove, the moving base has a screw hole along the axial direction of the rail groove, the transmission element has an outer thread part corresponding to the screw hole, and the transmission element goes through the stopping wall of the body, the rail groove and connects to the screw hole of the moving base.

4. The cutting tool of claim 3, wherein the bottom of the roller base has a connecting part corresponding to the rail groove of the body, the connecting part is formed with a communicating hole along the axial direction of the rail groove, and the transmission element goes through the communicating hole and connects to the screw hole of the moving base.

5. The cutting tool of claim 1, wherein the end surface of the stopping wall toward the rail groove is recessed with one or more accommodating parts, the end surface of the roller base toward the stopping wall has installation parts corresponding to the accommodating parts, one end of each of the elastic elements urges against the corresponding accommodating part, and the other end urges against the corresponding installation part.

6. A cutting tool, comprising:
a body, whose one side has a rail groove and whose other side away from the rail groove is extended upward with a stopping wall;
a moving base, which is installed in the rail groove of the body with the end thereof facing the stopping wall has a cutting wheel, connected with a transmission element, and driven by the transmission element to move along the rail groove; and
a roller base, which is interposed between the moving base and the stopping wall, wherein a plurality of elastic elements are interposed between the roller base and the stopping wall, and the roller base is provided with at least two rollers opposite to the cutting wheel.

7. The cutting tool of claim 6, wherein a track with two opposite sidewalls is formed between the rail groove and the stopping wall; the two sidewalls of the track are formed with a sliding groove, respectively; the bottom of the roller base has a connecting part corresponding to the track; the roller base has a connecting hole at the positions opposite to the two sliding grooves, respectively; a limiting element is disposed in the two connecting holes, respectively; the outer diameter of the limiting element is smaller than the hole diameter of the sliding groove; and the two limiting elements are installed in the corresponding sliding grooves.

8. The cutting tool of claim 6, wherein the moving base has a screw hole along the axial direction of the rail groove, the transmission element has an outer thread part corresponding to the screw hole, the transmission element connects to the screw hole of the moving base so that the moving base moves along the rail groove as one turns the transmission element.

9. The cutting tool of claim 6, wherein the end surface of the stopping wall facing the rail groove is recessed with a plurality of accommodating parts, the end surface of the roller base facing the stopping wall has installation parts opposite to the accommodating parts, one end of each of the elastic elements urges against the corresponding accommodating part, and the other end urges against the corresponding installation part.
